(19) United States
(12) Patent Application Publication
(10) Pub. No.: US 2007/0279776 A1
(43) Pub. Date: Dec. 6, 2007

(54) MIRROR

(75) Inventors: David J. Merten, Manitowoc, WI (US); Jay Z. Muchin, Manitowoc, WI (US)

Correspondence Address: RATHE PATENT & IP LAW, 10611 W. HAWTHORNE FARMS LANE, MEQUON, WI, 53097, US

(73) Assignee: M Group, Inc., Manitowoc, WI (US)

(21) Appl. No.: 11/744,441

(22) Filed: May 4, 2007

Related U.S. Application Data
(60) Provisional application No. 60/797,708, filed on May 4, 2006.

(51) Int. Cl. G02B 5/08

(52) U.S. Cl. 359/846

(57) ABSTRACT

Various embodiments and methods relating to a deformable mirror are disclosed.

### CROSS-REFERENCE TO RELATED PATENT APPLICATIONS

The present application claims priority under 35 USC §119 from co-pending U.S. provisional U.S. Patent Application Ser. No. 60/797,708 filed on May 4, 2006 by David J. Merten and Jay Z. Muchin and entitled MIRROR, the full disclosure of which is hereby incorporated by reference.

### BACKGROUND

Mirrors are sometimes used to view oneself or a surrounding environment. Such mirrors have a predefined shape with their uses strictly limited to particular environments.

### BRIEF DESCRIPTION OF THE DRAWINGS

FIG. 1 is a schematic illustration of a reflective system according to an example embodiment.

FIG. 2 is a schematic illustration of another embodiment of the reflective system of FIG. 1 according to an example embodiment.

FIG. 3 is a schematic illustration of another embodiment of the reflective system of the FIG. 1 according to an example embodiment.

FIG. 4 is a front perspective view of another embodiment of the reflective system of FIG. 1 according to an example embodiment.

FIG. 5 is an exploded perspective view of the reflective system of FIG. 4 according to an example embodiment.

FIGS. 6A-6C are sectional views illustrating the reflective system of FIG. 4 in various states according to an example embodiment.

FIG. 7 is a front elevational view of the reflective system of FIG. 1 a non-deformed state according to an example embodiment.

FIGS. 8A, 8B, 9A, 9B, 10A, 10B, 11A and 11B are front elevational views of the reflective system of FIG. 1 in various deformed states according to an example embodiment.

FIG. 12 is a perspective view illustrating the reflective system of FIG. 1 employed in a retail environment according to an example embodiment.

### DETAILED DESCRIPTION OF THE EXAMPLE EMBODIMENTS

FIG. 1 is a schematic illustration of reflective system 10 according to one example embodiment. Reflective system 10 is configured to reflect light in a substantially specular fashion, permitting persons to view themselves. In particular, reflective system 10 is configured to change between different reflective states in which light is reflected in different manners to vary the reflected appearance of the person before reflective system 10.

As schematically shown by FIG. 1, reflective system 10 includes mirror 12, manual actuator 14, powered actuator 16, clock/timer 20, controller 24, input 26, audio output 30 and sensor 32. Mirror 12 comprises a mirror configured to be deformed along at least one axis such that light reflected from mirror 12 is bent or distorted, providing a person before mirror 12 with a distorted or changed representation. In a particular example illustrated, mirror 12 is configured to be deformed along a plurality of axes including a horizontal axis and a vertical axis. Deformation along a horizontal axis may cause the person or object reflected by mirror 12 to appear taller or shorter. Deformation along the vertical axis may cause the person or object to appear wider or thinner. Deformation along additional axes or combination of axes may change the reflected appearance in other manners.

In the particular embodiment illustrated, mirror 12 includes layers 50, 52 and 54. Layer 50 comprises one or more layers of one or more flexible polymeric materials which serve to support layers 52 and 54. Layer 50 is sufficiently flexible (formed from an appropriate material and having an appropriate thickness) so permit layer 50 to be substantially deformed by manual actuator 14 or powered actuator 16. In one embodiment, layer 50 comprises an acrylic plastic sheet having a thickness of less than 2 mm. In another embodiment, layer 50 comprises a polycarbonate sheet and a thickness of less than about 2 min. In other embodiments, other materials having other thicknesses may be employed. In the particular embodiment illustrated in which layer 52 is positioned behind or rearward of layer 50, layer 50 is additionally transparent so as to permit light to pass through layer 52 layer 52. In other embodiments in which layer 52 is positioned forward of layer 50, layer 50 need not be transparent.

Layer 52 comprises a layer of reflective material coupled to layer 50. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

Layer 52 is formed from an appropriate material and having an appropriate thickness such that layer 52 deforms with the deformation of layer 50. Layer 50 is configured to reflect light that is passed through layer 50 back towards the person or object before mirror 12. In one embodiment, layer 52 comprises a metal, such as aluminum. In other embodiments, other reflective materials may be employed.

In the example illustrated, layer 52 is directly adhered or bonded to layer 50. For example, in one embodiment, layer 52 comprises a metallized surface formed upon layer 50. The layer of metal is sufficiently thin so as to be deformable with layer 50. In other embodiments, layer 52 may be mounted or supported directly adjacent to layer 50.

[symbol]

The above table provides example dimensions and materials for layer 52. In other embodiments, layer 52 may be formed from other specular reflective materials and may have other dimensions.

According to one embodiment, mirror 12 may comprise a reflective acrylic-plexiglass mirror comprising a transparent acrylic plastic sheet for indoor use and vacuum metallized with aluminum on its back surface. An opaque back coat may additionally be provided to protect the metallized surface. In yet other embodiments, other materials may be used in lieu of acrylic. Examples of such materials include, but are not limited to, polyethylene teraphalate (PET) or polycarbonate. As compared to glass mirrors, such a mirror 12 is lightweight, breakage resistant and can be more safely and easily installed as compared to glass mirrors. Such a mirror may be cut with available saws and routers to be drilled in machine. Such a mirror 12 may also be formed by strip eating and bending and can be surface decorated by silk-screening, spray painting or other artistic techniques. In embodiments where mirror 12 comprises such a plexiglass mirror, mirror 12 may be bonded to other surfaces using an acrylic contact cement, white silicone cement or double-faced foam tape.

Layer 54 comprises a layer positioned adjacent to layer 52 and configured to protect layer 52 from scratches or other damage which may result from the relatively thin nature of layer 52. In one embodiment, layer 54 is opaque. In other embodiments, layer 54 may be reflective on both faces or may be reflective on a single face. In other embodiments, layer 54 may be transparent. Like layers 50 and 52, layer 54 is formed from one or more materials and has a thickness such at layer 54 deforms with the deformation of layer 50 and layer 52. Still other embodiments, layer 54 may be omitted. In still other embodiments, mirror 12 may have other configurations.

Manual actuator 14 comprises a device configured to change mirror 12 between different states of deformation or different curvatures or shapes using manually applied force. Manual actuator 14 does not rely upon any powered device such as a motor, solenoid or the like. In one embodiment, manual actuator 14 may comprise one or more knobs, levers, handles., push buttons and the like mechanically connected to mirror 12 such that force applied to the knobs, levers, handles, push buttons and the like is transferred to mirror 12 to move mirror 12 between different deformation states. The mechanical connection between the knobs, levers, handles, push buttons and the like may be achieved by one or more linkages, cams, gears, rollers and the like.

Powered actuator 16 comprises a device configured to change mirror 12 between different states of deformation or different curvatures or shapes using powered force. Powered actuator 16 comprises one or more powered force sources such as one or more motors, solenoids, cylinder-piston assemblies and the like operably coupled to mirror 12 to move mirror 12. In one embodiment, powered actuator 16 may derive power from one or more batteries. In other embodiments, powered actuator 16 may derive power from an external electrical connection. Such powered force sources are operably coupled to mirror 12 by one or more linkages, cams, gears, rollers and the like.

In a particular example illustrated, manual actuator 14 and powered actuator 16 share a common set of mirror engaging structures 58. Force is applied to engaging structures 58 which transmit the force to mirror 12 to deform mirror 12. In other embodiments, manual actuator 14 and powered actuator 16 may have independent or dedicated mirror engaging structures 58.

In the particular example illustrated, each of manual actuator 14 and powered actuator 16 are configured to retain mirror 12 in a particular deformed state once mirror 12 has been moved to the desired state. For example, manual actuator 14 is configured to enable a person to selectively locking the positioning of mirror 12 by actuating an over-center cam mechanism, a snapping mechanism or other similar structure. Powered actuator 16 may employ similar locking or retention mechanisms or may retain mirror 12 in a desired state as result of additional power to actuator 16 being terminated. In yet other embodiments, manual actuator 14 or powered actuator 16 may alternatively be configured to temporarily hold near 12 in a deformed state while manual force is being applied to manual actuator 14 or while power is being supplied to powered actuator 16, wherein upon cessation of such force or power, mirror 12 returns to its original shape prior to deformation, such as a substantially planar shape.

Manual actuator 14 and powered actuator 16 enable reflective system 10 to provide a user with a choice of how deformation of mirror 12 is accomplished. Manual actuator 14 permits mirror 12 to be deformed even when a source of electricall power is not available or when energy conservation is desired. Powered actuator 16 provides a person with the choice of deforming mirror 12 without physical application of force. In particular embodiments, powered actuator 16 may enable mirror 12 to be more precisely deformed to more precisely attain desired effects. Although reflective system 10 is illustrated as including both manual actuator 14 and powered actuator 16, in other embodiments, reflective system 10 may alternatively be provided with only one of manual actuator 14 or powered actuator 16. Use of only manual actuator 14 enables system 10 to be less expensive, more compact and lighter in weight. Use of powered actuator 16 provides system 10 with greater functional versatility.

In the particular embodiment illustrated, powered actuator 16 is configured to change mirror 12 between multiple states without manual input between the states. For example, actuator 16 may bend mirror 12 by a first degree along a first axis at a first point in time and then at a second point time, without any interaction from a person, and mirror 12 by a second degree along the first axis or along a second axis in the second point in time. As shown by FIG. 1, in one embodiment, system 10 additionally includes clock/timer 20. Clock/timer 20 provides output or signals to powered actuator 16 which caused powered actuator 16 to automatically change mirror 12 between different deformation states. For example, in particular embodiments, powered actuator 16 may supply force to mirror 12 to deform mirror 12 at pre-selected times or at pre-selected intervals. In other embodiments, clock/timer 20 may be omitted.

Controller 24 comprises a processing unit configured to generate control signals directing powered actuator 16. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 36 is not limited to any specific combination of hardware circuitry and software, nor to any particular source for the instructions executed by the processing unit.

In the particular example illustrated, controller 24 generates control signals to change mirror 12 between different deformation states based upon instructions contained in a memory associated with controller 24. In one embodiment, controller 24 generates such control signals based upon at least one of input 26, audio output 30 and sensor 32. Input 26 comprise a device configured to facilitate input of commands are instructions to controller 24. In one embodiment, input 26 comprises an electrical are optical connection with an external device or system. For example, in one embodiment, input 26 may comprise an optical cable, an electrical cable, or a wireless communication mechanism, such as infrared or radiofrequency. In other embodiments, input 26 may comprise device configured to facilitate input of commands directly from a person. For example, input 26 may comprise a keyboard, a mouse, a tablet, a stylus, a microphone and voice recognition software, a pushbutton, a slide bar, a toggle switch and the like.

Input 26 enables a person to enter commands instructing controller 24 to generate control signals which direct actuator 16 to deform or change mirror 12 as desired. For example, a person may enter commands instructing controller 24 to cause mirror 12 to be deform at predetermined times are predetermined time intervals using an internal clocks or timer of controller 24. In other embodiments, input 26 may be used by person to instruct controller 24 to cause actuator 16 to deform mirror 12 at certain times or for certain periods of time based on audio output 30 or sensor 32. In yet other embodiments, input 26 may be used to directly command controller 24 to change mirror 12 to or from a particular deformation states. In other embodiments, input 26 may be omitted.

Audio output 30 comprises a device configured to output audio or sound. Audit output 30 is coupled to mirror 12 to provide sound output proximate to mirror 12. Audio output 30 comprises a device including a speaker. Examples of audio output 30 include an MP3 player, a stereo, television, and the like. As indicated by line 60, audio output 30 using communication with controller 24, either wirelessly or through optical or electrical connections. Based upon signals from audio output 30, controller 24 generates control signals directing actuator 16 to change mirror 12 between different deformation states. For example, controller 24 may generate control signals causing near 12 to be changed between different states in a timed fashion synchronized with the beat of the sound provided by audio output 30. In particular embodiments, controller 24 is further configured to generate control signals directing operation of audio output 30. In other embodiments, audio output 30 may be driven by other devices. In yet other embodiments, controller 24 may not be directly connected to audio output 30, wherein controller 24 bases the changing of mirror 12 between different deformation states upon signals from sensor 32 representing output from audio output 30. In still other embodiments, audio output 30 may be omitted.

Sensor 32 comprises a device configure to sense environmental conditions about mirror 12 and to generate signals representing such environmental conditions. As indicated by line 62, such signals are communicated to controller 24, wherein controller 24 generates control signals directing powered actuator 16 to change mirror 12 between different deformation states based upon such signals. For example, in one embodiment, sensor 32 may be configured to detect environmental sound (such as music or a person speaking), wherein controller 24 adjusts deformation of mirror 12 based upon such environmental sound. In other embodiments, sensor 32 may comprise the light sensor, wherein controller 24 adjusts the deformed state of mirror 12 based upon environmental lighting conditions of mirror 12. In yet other embodiments, sensor 32 may comprise an optical sensor configure to sense characteristics of the person or object before mirror 12, wherein controller 24 adjusts deformation of mirror 12 based on the sense characteristics of the person or object before mirror 12. In yet other embodiments, sensor 32 may be omitted.

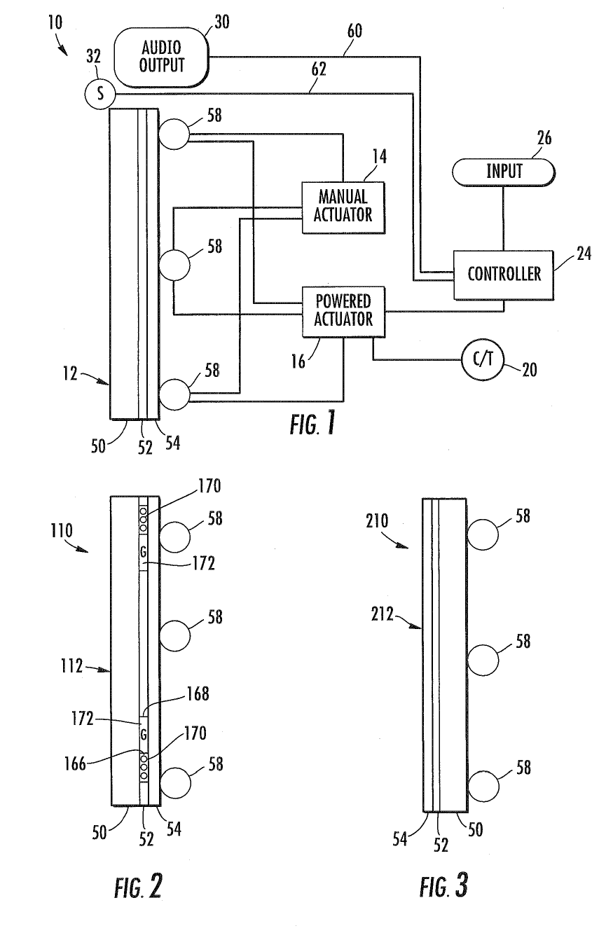

FIG. 2 schematically illustrates reflective system 110, another embodiment of reflective system 10. Reflective system 110 is similar to reflective system 10 except that system 110 includes mirror 112 in lieu of mirror 12. Those remaining elements of system 110 (some of which are shown in FIG. 1) are identical to the elements of system 10. Mirror 112 is similar to mirror 12 except that layer 52 includes openings 166 and 168, light sources 170 and graphics 172. Openings 166 and 168 extend through layer 52 and form cavities for receiving light sources 170 and graphics 172, respectively. Light sources 170 comprise light emitters positioned within openings 166. Such light emitters may comprise diodes, incandescent bulbs, fluorescent bulbs or other light emitting elements. In one embodiment, light sources 170 are configured to change between different light emitting states in which different colors or shades of like are emitted. Such light passes through openings 166 and through transparent layer 50. In particular embodiments, controller 24 (shown in FIG. 1) generates control signals causing deformation of mirror 12 based upon the changing of light emitting states. For example, mirror 12 may be deformed in a first matter as red light is emitted and in a second manner as blue light is emitted by light sources 170. In particular embodiments, layer 54 may be reflective or include reflective portions adjacent to light sources 170 opposite layer 50 to further reflect light through opening 156 and through layer 50. In other embodiments, such light sources 170 may be omitted.

Graphics 172 comprise alphanumeric symbols, pictures, photos and the like located within or adjacent to openings 168. Such graphics may be personalized photos and the like. Graphics 172 and light sources 170 are coupled to mirror 112 so as to move during the deformation of mirror 112. In other embodiments, graphics 172 may be emitted or may be provided as part of a frame about mirror 112.

FIG. 3 schematically illustrates reflective system 210, another embodiment of reflective system 10. Reflector system 210 is similar to reflective system 10 except that reflective system 210 includes mirror 212 in lieu of mirror 12. Those remaining elements of system 210 (some of which are shown in FIG. 1) are identical to the elements of system 10. As shown by FIG. 3, near 212 is similar to mirror 12 except that the order or arrangement of layers 50, 52 and 54 is altered. In particular, layer 50 comprise back or rearward layer while layer 54 comprises a front layer. In such an embodiment, layer 50 need not be transparent. In such an embodiment, layer 54 includes transparent portions. As with system 10, layer 50 serves as a support or backbone for mirror 212 while layer 54 protects the reflective material of layer 52.

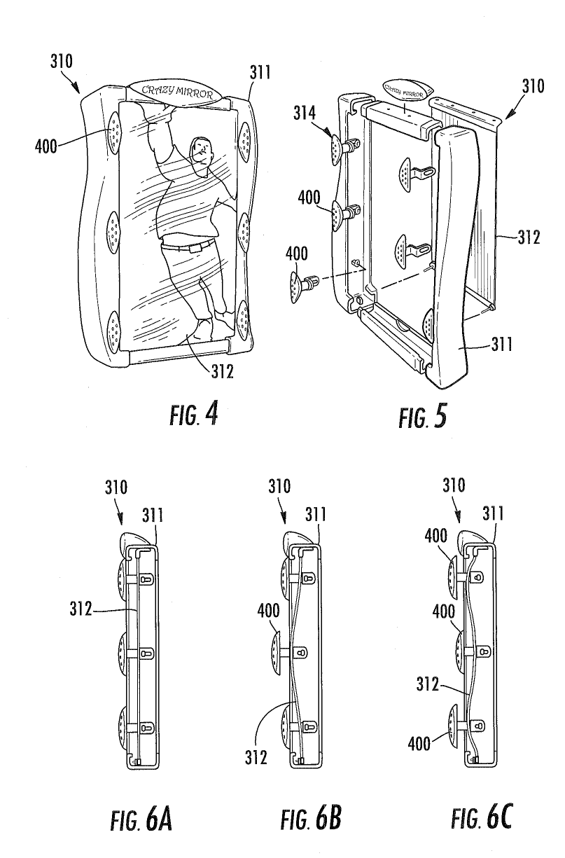

FIGS. 4-6 illustrate reflect system 310, another embodiment of reflective system 10. FIG. 4 is a front perspective view of system 310. FIG. 5 is an exploded perspective view of system 310. FIGS. 6A, 6B and 6C illustrate system 310 in different states. System 210 includes frame 231, mirror 312 and manual actuator 314. Frame 311 comprises one or more structures for term as a base or housing for the remaining components of a system 310. Although illustrated as being rectangular, frame 311 may have other configurations. Frame 311 may be formed from various materials such as wood, plastic, metal or combinations thereof. Frame 311 may include various text and graphics including licensed art. Frame 311 may be configured to mount system 310 in various locations. For example, frame 311 may be configured to support system 310 as a wall-door mound, over-the-door mound or as a floor stand.

Mirror 312 comprises a mirror configured to be deformed along at least one axis such that light reflected from mirror 312 is bent or distorted, providing a person before mirror 312 with a distorted or changed representation. In a particular example illustrated, mirror 312 is configured to be deformed along a plurality of axes including a horizontal axis and a vertical axis. Deformation along a horizontal axis may cause the person or object reflected by mirror 312 to appear taller or shorter. Deformation along the vertical axis may cause the person or object to appear wider or thinner. Deformation along additional axes or combination of axes may change the reflected appearance in other mariners. According to one embodiment, mirror 312 is substantially similar to mirror 12 described above with respect to system 10. In other embodiments, mirror 312 to be similar to mirror 112 described above with respect to system 110 or mirror 212 described above with respect to system 210.

Manual actuator 314 comprises a device configured to change mirror 312 between different states of deformation or different curvatures or shapes using manually applied force. Manual actuator 314 does not rely upon any powered device such as a motor, solenoid or the like. In the particular embodiments shown, manual actuator 314 includes six actuation levers, buttons or knobs 400. Each of knobs 400 is movably supported by frame 311 and extends adjacent to a backside of mirror 312. Each knob 400 is further configured to be selectively retain one of a multitude of positions for deforming mirror 312. Knobs 400 enables a person to manually adjust the extent to which knobs 400 extend forward a frame 311 so as to adjust the deformation of mirror 312.

FIGS. 6A-6C illustrate various states of system 310 based upon positioning of a knobs 400 or manual actuator 314. FIG. 6A illustrates an act rest or neutral state in which mirror 312 resiliently returned to its natural, at-rest state in which mirror 312 is substantially planar. Each of knobs 400 is in substantially the same position with respect to frame 311. FIG. 6B illustrates system 310 in a first deformed state in which a middle knob 400 is moved and retained in a forward state, deforming a central portion of mirror 312 to provide mirror 312 with a convex surface proximate to the middle knob 400. FIG. 6C illustrates an opposite situation in which the upper and lower knobs 400 are moved to and retained in forward states with respect to middle knob 400. As a result, the same central portion of mirror 312 is held in a concave state proximate to the middle knob 400.

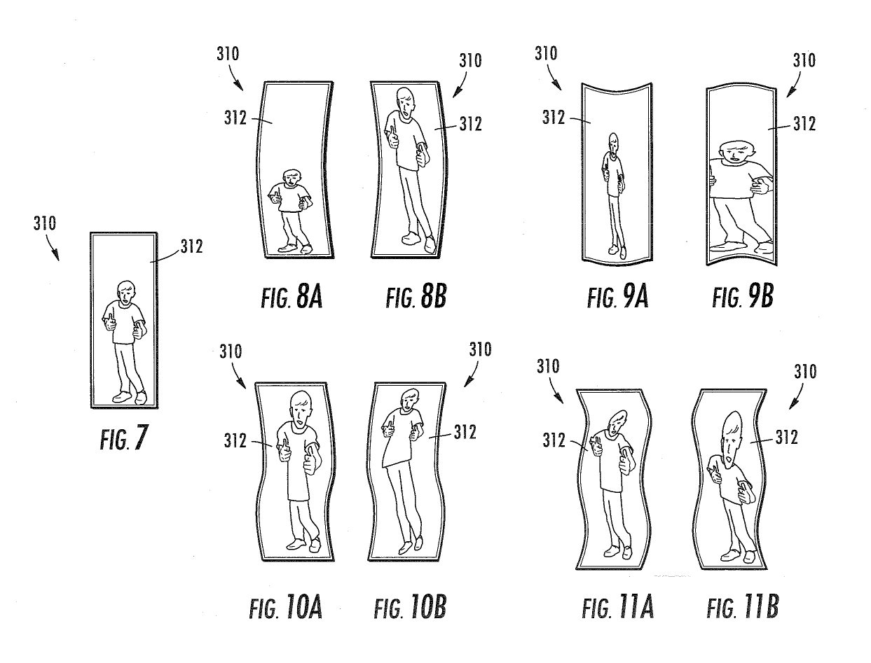

FIGS. 6B and 6C illustrate but two of many various states in which system 310 may be placed by selected limit and retention of knobs 400. Each of knobs 400 may be individually moved and retained in a forward state to provide multiple different combinations with each combination providing a different reflective representation. FIGS. 7-11 illustrate examples of various combinations.

FIG. 7 illustrates mirror 312 in the neutral state shown in FIG. 6A in which all of knobs 400 or in connection the same position with respect to frame 311 and mirror 312. FIG. 8A illustrates mirror 312 in a single wave vertically concave state. FIG. 8B illustrates mirror 312 in a single wave vertically convex state. FIG. 9 illustrates mirror 312 in a single wave horizontally concave state. FIG. 9B illustrates mirror 312 in a single wave horizontally convex state. FIGS. 10A and 10B illustrate mirror 312 in a double wave-lower concave state and a double wave-upper concave state, respectively. FIGS. 11A and 11B illustrate mirror 312 in a triple wave-middle concave state and a triple wave-middle convex state, respectively.

Although system 310 is illustrated as including six knobs 314, in other embodiments, system 310 may include a greater number of knobs were a fewer number of knobs. Although system 310 is illustrated as employing straight pole-action for deforming near 312, in other embodiments, system 310 may employed various cams are levers for alternatively you forming near 312 using manually applied power or force. In still other embodiments, system 310 may actuate knobs 400 additionally or alternatively using a powered source such as one or more electric solenoids, motor driven cams and linkages or the like.

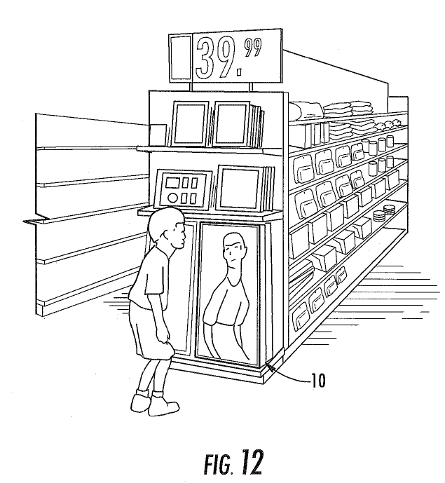

FIG. 12 illustrate illustrates one example use of system 10 (or alternatively system 110, 210 or 310). As shown by FIG. 12, systems 10, 110, 210 and 310 enhance retail marketing opportunities. By placing such systems in a retail environment, even when such systems are not for retail sale, the sale of other items may be enhanced. For example, grouping such systems with other deforming framed item in a retail environment permits systems 10, 110, 210 and 310 to serve as an attractor to assist in the sale of the non-deforming framed items. Such systems are especially beneficial in retail environments such as a children's retail environment, such as a toy department or juvenile bedroom or clothing departments, and a retail environment comprising an area retailing framed articles. In one embodiment, systems 10, 110, 210 and 310 are place at an end of an aisle to better serve as an attractor.

For example, according to one embodiment, systems 10, 110, 210 and 310 may be employed as part of a business method of selling framed items in a retail situation, wherein at least two items are grouped in a related environment and wherein one of the items is a deformable mirror such the deformable mirror is an attractor to sell non-deforming framed items. In particular, the attraction of a deformable mirror in a retail environment may be used to draw a prospective buyer to subsequent purchase a non-deforming framed item in a shelf in the same geographic location. As another example, a deformable mirror may alternatively be used in a toy department for attracting customers to a non-deforming framed item at the same store, but in a non-toy department. The concept of “related environment” can be shelving spaces within the same aisle, retail departments within a retail store, retail stars within a retail channel of trade, and, but not limited to, a product offered to a retail buyer within a group of products being offered.

In one embodiment, such a deform mirror may be placed to attract children or juveniles (1) to toys by meeting place within approximate 248 feet of such toys, (2) to bedroom accessories by being placed within approximate 48 feet of such bedroom accessories, (3) to juvenile or children's furniture by being placed within approximate 16 feet of such furniture or (4) to mirrors or other framed items by being placed within approximately 8 feet of a mirrored or framed items.

In other embodiments, deformable mirrors, such as provided by systems 10, 110, 210 and 310 to be provided other locations with respect to products at a retail store. In yet other embodiments, systems 10, 110, 210 and 310 may be employed in other non-retail environments. For example, systems 10, 110, 210 and 310 may additionally be employed in doctor and dentist waiting rooms, daycare facilities, YMCA or YWCA facilities, malls, retail chains stores, such as shoe stores or carnivals.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a mirror;
a first actuator coupled to the mirror and configured to deform the mirror.

2. The apparatus of claim 1, wherein the first actuator is configured to deform the mirror using manually applied force.

3. The apparatus of claim 2, wherein the first actuator is powered.

4. The apparatus of claim 3, wherein the first actuator is configured deform the mirror along a horizontal axis.

5. The apparatus of claim 4, wherein the first actuator is configured to deform the mirror along the vertical axis.

6. The apparatus of claim 1, wherein the first actuator is configured to deform the mirror along a plurality of axes.

7. The apparatus of claim 1, wherein the first actuator is configured to engage the mirror at a plurality of spaced locations.

8. The apparatus of claim 1 further comprising a frame at least partially about the mirror.

9. The apparatus of claim 8, wherein the first actuator engages the frame to deform the mirror.

10. The apparatus of claim 1, wherein the first actuator is configured to retain the mirror in a deformed state.

11. The apparatus of claim 1, wherein the mirror as a vertical height of at least 3 feet.

12. The apparatus of claim 1 further comprising a second actuator, wherein the first actuator is a manual actuator and wherein the second actuator is a powered actuator.

13. The apparatus of claim 1, wherein the first actuator is a powered actuator configured to change the mirror between a plurality of distinct non-planar states without user input between changing of the states.

14. The apparatus of claim 13 further comprising a clock or timer, wherein the first actuator changes the mirror at selected times based upon output from the clock or timer.

15. The apparatus of claim 13 further comprising a controller configured to generate control signals, wherein the first actuator changes the mirror in response to the control signals.

16. The apparatus of claim 15 further comprising an input in communication with the controller, wherein the controller generates the control signals based upon the input.

17. The apparatus of claim 15 further comprising a sensor in communication with the controller, wherein the controller generates the control signals based upon signals received from the sensor.

18. The apparatus of claim 13 further comprising an audio output, wherein the first actuator changes the mirror between the plurality of distinct states based upon signals from the audio output.

19. The apparatus of claim 1 further comprising a light source coupled to the mirror.

20. The apparatus of claim 19, wherein the light source is coupled to the mirror so as to move with the mirror.

21. The apparatus of claim 19 wherein the light source is configured to change between different light emission states in which different colors of light are emitted.

22. The apparatus of claim 21, wherein the first actuator is configured to change the mirror between distinct deformation states based upon changing of the light source between the different light emission states.

23. The apparatus of claim 1, wherein the mirror comprises:
a flexible polymeric support layer; and
a reflective layer over the support layer.

24. The apparatus of claim 23, wherein the support layer is transparent.

25. The apparatus of claim 23, wherein the reflective layer includes at least one opening.

26. The apparatus of claim 25 further comprising a light source configured to transmit light through the at least one opening.

27. The apparatus of claim 25 further comprising a graphic configured to be viewed through the at least one opening.

28. The apparatus of claim 27, wherein the graphic is configured to move with the mirror during deformation of the mirror.

29. The apparatus of claim 23, wherein the reflective layer includes at least one opening and wherein the apparatus configured to permit viewing through the apparatus via the opening.

30. A method comprising:
changing a mirror between a plurality of deformed states.

31. The method of claim 30, wherein the mirror is changed between the plurality of states without manual input between the states.

32. The method of claim 30, wherein the mirror is changed between the states based upon signals from a clock or timer.

33. The method of claim 30, wherein the mirror is change between the states based upon signals from an audio output.

34. The method of claim 30, wherein the mirror is changed between the states based upon changing of a light source between different light emitting states.

35. The method of claim 30 further comprising grouping the mirror with a non-deforming framed item in a retail environment, wherein the mirror is an attractor to assist in a sale of the non-deforming framed item.

36. A method comprising:
grouping at least two items in a related environment, wherein one of the items is a deformable mirror and wherein the formal mirror is an attractor to sell non-deforming framed items.
